(19) United States
(12) Patent Application Publication
(10) Pub. No.: US 2004/0043915 A1
(43) Pub. Date: Mar. 4, 2004

(54) Fabric care composition

(75) Inventor: Nicola Whilton, Bebington (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/643,235

(22) Filed: Aug. 18, 2003

(30) Foreign Application Priority Data
Aug. 19, 2002 (GB) 0219281.3

(51) Int. Cl. C11D 3/37

(52) U.S. Cl. 510/475

(57) ABSTRACT

This invention relates to a fabric care composition comprising a cross-linking agent and a hydroxyl-containing polymer, a method of treating fabric with such a composition and the use of such a composition to impart crease and/or wrinkle resistance to a fabric and/or to increase the tearing resistance of a fabric.

### TECHNICAL FIELD

This invention relates to a fabric care composition comprising a cross-linking agent and a hydroxyl-containing polymer, a method of treating fabric with such a composition and the use of such a composition to impart crease and/or wrinkle resistance to a fabric and/or to increase the tearing resistance of a fabric.

### BACKGROUND OF THE INVENTION

The laundry process generally has several benefits for fabric, the most common being to remove dirt and stains from the fabric during the wash cycle and to soften the fabric during the rinse cycle. However, there are numerous disadvantages associated with repeated use of conventional laundry treatment compositions and/or the actual laundry process.

The creasing of fabrics is an almost inevitable consequence of cleaning fabrics, such as in a domestic laundering process. Fabrics also become creased in wear. Creasing can be a particular problem for fabrics, which contain cellulosic fibres such as cotton, because the creasing is often difficult to remove. Generally, the creases, which are developed in a fabric during laundering, are removed by ironing. However, because ironing is seen as a time consuming chore, there is an increasing trend for fabrics to be designed such that the need for ironing is reduced and/or the effort required for ironing is lower.

Compositions for reducing the wrinkling of fabric are described in WO 96/15309 and WO 96/15310. The compositions contain a silicone and a film-forming polymer and it appears that it is the lubricating effect of the silicone, which is responsible for their anti-wrinkle properties. This conclusion is supported by the fact that a wide variety of polymers is mentioned as being suitable for use in the compositions.

Industrial treatments of fabrics to reduce their tendency to crease are known.

JP-A-04-50234 describes a textile treatment in which the crease resistance of a plain weave cotton fabric is increased by applying a so-called “shape memory resin” to the fabric. However, this document teaches that the resin is applied to the fabric at a relatively high amount of 10% by weight on weight of fabric and it is not clear how this level of resin affects other properties of the fabric. Furthermore, treatment of the fabric with the resins is followed by a step of drying at 80° C. and the shape memory function is described as being heat-sensitive, with deformations at normal temperatures being restored to the original shape on heating at a specific temperature.

Durable press treatments (a.k.a. “permanent” press treatments) in the textile industry are well known. In the 1960's, it was known to use polycarboxylic acids for permanent press treatment of textiles. Generally, cellulose fibre can be cross-linked and esterified with polycarboxylic acids, particularly those with two or more carboxylic acid groups. Esterification is achieved upon heating the treated cellulose fibres such as by ironing or other forms of heat pressing. Curing catalysts, such as phosphorous containing salts, are also known to serve to aid cross-linking. Examples of U.S. patents relating to durable press finishing of cotton textile with polycarboxylic acids include: U.S. Pat. Nos. 4,936,865 (Welch et al.), 4,820,307 (Welch et al.), 4,795,209 (Welch et al.) and 5,221,285 (Andrews et al,). The contents of these patents are incorporated by reference. Compounds such as formaldehyde-based polymers, DMDHEU (dimethylol dihydroxy ethylene urea) and BTCA (1,2,3,4-butane tetracarboxylic acid) may be used as the cross-linking agent. However, these treatments have the disadvantage of reducing the tensile strength of the fabrics. Also, the high cure temperatures and long cure times required for such treatment have effectively prevented the use of such treatments in a domestic laundry environment.

WO 98/04772 describes the use of a composition comprising a polycarboxylic acid or a derivative thereof, such as BTCA, in a domestic process to reduce creasing of fabrics. Preferably, the composition is incorporated into a rinse conditioner composition and curing of the composition is achieved by ironing. However, treatment with such a composition in a domestic process is still expected to have the disadvantage of reducing the tensile strength of the fabric as has been observed in industrial processes.

WO 01/44426 describes a method for providing fabrics with durable wrinkle reduction benefits and with improved softness which can be used in both domestic and industrial processes. A preferred embodiment utilises silicone-containing compounds, such as silicon carboxylates, silanol fluids, silanols and hydroxy-containing organically modified silicone fluids, in conjunction with a cross-linking agent, such as BTCA, to form cross-linked matrices with cellulosic fibres.

GB 1023471 discloses a process for imparting good dry and wet resiliency to a cellulosic fabric which comprises cross-linking the hydroxy group of the cellulosic fabric with a strong base catalysed cross-linking agent while the fabric contains a strong base and less than 35% by weight total moisture. However, there is no suggestion that the resulting cellulosic fabric has crease and/or wrinkle resistant properties.

U.S. Pat. No. 4,226,264 discloses the preparation of various elastic amylose polymers and their use for forming films, filaments and shaped articles, such as tubular sausage casings. However, there is nothing in this document to suggest that such polymers could be useful in laundry applications.

It has now been discovered that, by incorporating a hydroxyl-containing polymer into a composition comprising a cross-linking agent, the disadvantage of reducing the tensile strength (tearing resistance) of the fabric is overcome and the resistance to creasing/wrinkling of the fabric is surprisingly improved.

The present invention therefore aims to reduce the tendency for fabrics to become wrinkled or creased.

The invention further aims to reduce the deleterious effects on tensile strength (tearing resistance) of fabrics, which some conventional anti-wrinkle treatments impart.

In addition, the invention aims to provide a fabric treatment which can be utilised in an industrial or domestic environment.

### SUMMARY OF THE INVENTION

In a first aspect, the present invention provides a fabric care composition comprising a cross-linking agent and a hydroxyl-containing polymer.

In a second aspect, the invention provides a method of treating fabric which comprises treating the fabric with a fabric care composition as defined above and curing the composition.

In a third aspect, the invention provides the use of a composition as defined above to impart crease and/or wrinkle resistance to a fabric.

In a fourth aspect, the invention provides the use of a composition as defined above to increase the tensile strength (especially the tear strength or tearing resistance) of a fabric.

### DETAILED DESCRIPTION OF THE INVENTION

The present invention involves the development of a composition for fabric care applications which is suitable for use in an industrial or domestic environment. In general terms, the compositions comprise a small organic molecule which is capable of covalently reacting with groups on fabrics and a polymer which does not constitute the fabric which is capable of reacting with the small organic molecule. The small organic molecule is termed a “cross-linking agent” and the polymer is specifically a hydroxyl-containing polymer, preferably a helical hydroxyl-containing polymer. Optionally, a catalyst may be provided to promote reaction of cross-linking agent with the fabric and the hydroxyl-containing polymer.

When a fabric is treated with a fabric care composition according to the present invention, it is thought that a cross-linked fabric-polymer-fabric matrix is produced in which the hydroxyl-containing polymer is held between fibres of the fabric by molecules of the cross-linking agent acting as internal cross-linkers. In prior art internally cross-linked systems, such as those described in U.S. Pat. Nos. 4,936,865, 4,820,307 and 4,795,209, the internal cross-linkers form small, rigid covalent bonds between fibres of the fabric. The internal rigid matrix thus formed improves wrinkle recovery of the fabric.

However, the tear strength of the fabric is reduced due to inflexibility of the matrix. In contrast, the hydroxyl-containing polymer in the cross-linked fabric-polymer-fabric matrix produced by the composition of the present invention appears to function as a miniature spring producing a flexible matrix. This flexible matrix gives improved wrinkle recovery of the fabric over rigid prior art internally cross-linked systems. In addition, the increased elasticity of the matrix counteracts the tear strength negative observed in prior art systems due to the flexible spring effect.

Cross-Linking Agents

A wide variety of cross-linking agents can be used in the composition of the invention. Generally, they are difunctional as such functionality is necessary to form a bridge between the hydroxyl-containing polymer and the fabric. Preferably, the cross-linking agent should be substantially linear. It should also be substantially soluble in a liquid medium so that it will be in a form suitable for reaction.

Several types of functional groups are capable of reacting with a hydroxyl group on the hydroxyl-containing polymer and may be included as cross-linking agents. These functional groups are well known to those skilled in the art. Typical functional groups which can react directly with the hydroxyl group include an isocyanate, a carboxylic acid, an acyl halide, an epoxide, an aldehyde, an anhydride, an imine, and the like.

Typical isocyanate cross-linking agents are the alkylene and cycloalkyl diisocyanates such as hexamethylene diisocyanate, butylene diisocyanate, methylene dicyclohexyl p,p′ diisocyanate, and the like. Aromatic polyfunctional isocyanates such as tolylene diisocyanate and phenylene diisocyanate can also be used.

Acid cross-linking agents having at least 2 carboxylic acid groups can be used for cross-linking hydroxyl-containing polymers to form elastic polymers. Examples of these acids include saturated acids such as adipic, succinic, phthalic, isophthalic, glutaric, malonic, sebacic camphoric; alpha-beta unsaturated dicarboxylic acids such as fumaric, maleic, itaconic, and citraconic; and dimer acids such as dimerised oleic and maleinised copolymers such as maleinised methyl vinyl ether and maleinised butadiene.

Alpha-beta unsaturated monocarboxylic acids can also be used for cross-linking hydroxyl-containing polymers. Examples of alpha-beta mono unsaturated acids include allylic, methacrylic, and acrylic.

Acid anhydrides can be used as well as the acid cross-linking agents recited above as the anhydride group can be hydrolysed to form an acid or directly reacted. Examples of appropriate anhydrides include cinnamic, succinic, phthalic, glycolic, maleic, fumaric, and the like.

Acyl halides can also be used for effecting cross-linking of the hydroxyl-containing polymer. The acyl halides react similarly to the acid and the acid anhydride cross-linking agents. However, as might be expected, when using an acyl halide, it is generally necessary to employ a halide acceptor to remove the by-product halide as it is produced. The acyl halides which can be used for practising the invention include corresponding acyl halides of the carboxylic acids listed above.

Epoxides can also be used as a cross-linking agent for the hydroxyl-containing polymers. Preferably, the epoxides are prepared by reacting an epichlorohydrin with a polyfunctional alcohol such as Bisphenol A, a cycloaliphatic alcohol, or amino phenol. Examples of epoxides include Bisphenol A-epichlorohydrin resin, cycloaliphatic epoxycarboxylate where the aliphatic portion has from about 1-3 carbon atoms, and bis(2,3-epoxycycloaryl) ethers, vinyl cyclohexene dioxide, or phenolic novolak-epichlorohydrin and diepoxydicyclohexyl carboxylate.

Another class of cross-linking agents are the dialdehydes. Examples of dialdehydes which can be used as a cross-linking agent include glyoxal, glutaraldehyde, dialdehyde polysaccharides, e.g., dialdehyde gum arabic, dialdehyde alginic acid and dialdehyde starch.

Examples of short chain cross-linking agents which can be used but are not preferred include formaldehyde, propylene oxide, ethylene oxide, ethylene imine and propylene imine.

The cross-linking agent preferably should have at least 3 carbon atoms in the structure as opposed to a shorter chain to provide significant elasticity to the polymer.

Preferably, the cross-linking agent is a polycarboxylic acid or a derivative thereof.

Polycarboxylic Acids

The polycarboxylic acids effective as cellulose cross-linking agents in this invention include aliphatic, alicyclic and aromatic acids either olefinincally saturated or unsaturated with at least three and preferably more carboxyl groups per molecule or with two carboxyl groups per molecule if a carbon-carbon double bond is present alpha, beta to one or both carboxyl groups. It is desirable that, to be reactive in esterifying cellulose hydroxyl groups, a given carboxyl group in an aliphatic or alicyclic polycarboxylic acid is separated from a second carboxyl group by no less than 2 carbon atoms and no more than three carbon atoms. In an aromatic acid, a carboxyl group is preferably ortho to a second carboxyl group if the first carboxyl is to be effective in esterifying cellulosic hydroxyl groups. It is thought that for a carboxyl group to be reactive, it must be able to form a cyclic 5- or 6-membered anhydride ring with a neighbouring carboxyl group in the polycarboxylic acid molecule. Where two carboxyl groups are separated by a carbon-carbon double bond or are both connected to the same ring, the two carboxyl groups are preferably in the cis configuration relative to each other if they are to interact in this manner.

The aliphatic or alicyclic polycarboxylic acid may also contain an oxygen or sulphur atom in the chain or ring to which the carboxyl groups are attached.

In aliphatic acids containing three or more carboxyl groups per molecule, the acid may contain a hydroxyl group attached to a carbon atom alpha to a carboxyl group.

In the context of the present invention it is preferred that the polycarboxylic acid or derivative contains at least 3 carboxyl groups, preferably between 4 and 8 carboxyl groups. It is especially preferred that at least 3 carboxyl groups, and more preferably 4 or more carboxyl groups, of the polycarboxylic acid or derivatives thereof are situated on adjacent carbon atoms. Also within the polycarboxylic acid or derivatives of the present invention are oligomers comprising monomers of the aforementioned polycarboxylic acids or derivatives thereof.

The oligomers may contain saturated or unsaturated monomers. Examples of the oligomeric polycarboxylic acids include polymaleic acid, cyclic polyacids containing varying degrees of unsaturation. Unsaturated linear oligomeric polycarboxylic acids may also be used.

The polycarboxylic acid derivatives of the invention may have 1 to 4 of the carboxyl groups esterified with a short chain (C₁₋₄, more preferably C₁₋₂) alcohol or form a salt with a suitable counterion, for example alkali metal, alkaline earth metal, ammonium compound. In addition, the polycarboxylic acid or its derivative may contain a long chain (C_{8-22,} preferably C₁₂₋₁₈) alkyl, alkenyl or acyl group.

The preferred polycarboxylic acids have the formula:

X—[CO₂R]ₙ

in which n is equal to 4 or more, X is a hydrocarbon backbone optionally substituted with functionalities including C₁₋₆ alk(en)yl, hydroxy, and acyloxy derivatives, R is independently selected from a C₁₋₄ alkyl chain or a C₂₋₄ alkenyl chain, or salt but is preferably H.

Examples of specific polycarboxylic acids which fall within the scope of the invention are the following: maleic acid, citraconic acid also called methylmaleic acid, citric acid also known as 2-hydroxy-1,2,3-propanetricarboxylic acid, itaconic acid also called methylenesuccinic acid; tricarballylic acid also known as 1,2,3-propanetricarboxylic acid; trans-aconitic acid also known as trans-1-propene-1,2,3-tricarboxylic acid; 1,2,3,4-butanetetracarboxylic acid; all-cis-1,2,3,4-cyclopentanetetracarboxylic acid; mellitic acid also known as benzenehexacarboxylic acid; oxydisuccinic acid also known as 2,2′-oxybis(butanedioic acid); thiodisuccinic acid; and the like.

Preferred polycarboxylic acids include 1,2,3,4-cyclopentanetetracarboxylic acid, citric acid and 1,2,3,4-butanetetracarboxylic acid (BTCA), with the latter compound being especially preferred.

Catalysts

Without being bound by theory it is thought that polycarboxy groups reduce creasing of the fabric in that crosslinking occurs via ester bonding. It is advantageous if a catalyst is used with compositions of the invention to aid the formation of the ester links. Preferred catalysts are 1,2,4-triazole, 1H-1,2,3-triazole, 1H-tetrazole, 3-methyl pyrazole, 3-methyl pyridazine, 1H-purine, 2,3-pyrazine dicarboxylic acid, 2-dimethylamino pyridine, picolinic acid, 6-methyl-3,3-pyridine dicarboxylic acid, imidazole, 1-methylimidazole, 2-methylimidazole, 4-methylimidazole, 2-ethylimidazole, 1-vinylimidazole, 1,2-dimethylimidazole, 2-ethyl-4-methylimidazole. Other catalysts include salts of organic acids such as mono-, di- and tri-sodium citrate, mono- and di-sodium maleate, mono- and di-sodium fumarate, and similar salts of succinic and tartaric acids.

Inorganic catalysts may also be used, especially phosphorus-containing salts.

The most active and effective curing catalysts of this invention are alkali metal hypophosphites, which in anhydrous form have the formula MH₂PO₂, where M is an alkali metal atom.

A second class of curing catalysts employed in the present invention are alkali metal phosphites having the formula MH₂PO₃ and M₂HPO₃. These are nearly as active as alkali metal hypophosphites.

A third class of curing catalysts employed in the process of the present invention are the alkali metal salts of polyphosphoric acids. These are condensed phosphoric acids and encompass the cyclic oligomers trimetaphosphoric acid and tetrametaphosphoric acid, and acyclic polyphosphoric acids containing 2 to 50 phosphorus atoms per molecule including pyrophosphoric acid. Specific examples of effective catalysts in this class are disodium acid pyrophosphate, tetrasodium pyrophosphate, pentasodium tripolyphosphate, the acyclic polymer known as sodium hexametaphosphate, and the cyclic oligomers sodium trimetaphosphate and sodium tetrametaphosphate.

A fourth class of curing catalysts suitable in special cases in the process of the present invention are the alkali metal dihydrogen phosphates such as lithium dihydrogen phosphate, sodium dihydrogen phosphate and potassium dihydrogen phosphate.

It is especially preferred that the catalyst is sodium hypophosphite (Na₂H₂PO₂),

When the polycarboxylic acid is BTCA or citric acid, the preferred catalyst is NaH₂PO₂.

Hydroxyl-Containing Polymers

The hydroxyl-containing polymer may be any suitable polymer which contains a plurality of hydroxyl groups. However, in the context of the present invention, the term “hydroxyl-containing polymer” does not include hydroxyl-containing silicone polymers, such as silicon carboxylates, silanol fluids, silanols and hydroxyl-containing organically modified silicone fluids. Thus, it is preferred that the hydroxyl-containing polymer is a polymer which contains a plurality of hydroxyl groups but no silicon atoms. Preferably, the hydroxyl-containing polymer is a polymeric polyol or a polypeptide. Examples of polymeric polyols suitable for practising the invention include polysaccharides such as starch, sugar, cellulose, amylopectin, glycogen, poly(vinyl alcohol), poly(allyl alcohol), and the like. Examples of polypeptides suitable for making elastic products include collagen, elastin, gelatin, soy protein, polyaspartic acid, casein, poly α-benzyl glutamate, polyglutamic acid, and poly α-lysine.

It is preferred that the hydroxyl-containing polymer is selected from the group consisting of poly(alkenyl alcohols), polysaccharides, polypeptides, hydroxyalkyl-substituted nylons, and derivatives thereof. More preferably, the hydroxyl-containing polymer is a poly(alkenyl alcohol), a polysaccharide or a derivative thereof.

Poly(alkenyl Alcohols)

The “alkenyl” group in such compounds may be a branched or unbranched unsaturated hydrocarbon containing 1 to 12, preferably 1 to 6 and especially 1 to 4 carbon atoms. The alkenyl group may also be substituted. However, it is preferred that the alkenyl group is unsubstituted. Preferably, alkenyl groups are unbranched.

It is particularly preferred that the poly(alkenyl alcohol) is poly(vinyl alcohol) or poly(allyl alcohol), with poly(vinyl alcohol) being especially preferred. If poly(vinyl alcohol) is used, it is preferred that this has a molecular weight of 3,000 to 50,000, more preferably 3,000 to 20,000.

Polysaccharides

As used herein, the term “polysaccharides” includes natural polysaccharides, synthetic polysaccharides, polysaccharide derivatives and modified polysaccharides. Suitable polysaccharides for use in preparing the compounds of the present invention include, but are not limited to, gums, arabinans, galactans, seeds and mixtures thereof as well as cellulose and derivatives thereof.

Constituent saccharides preferably include, but are not limited to, one or more of the following saccharides: amylose, isomaltose, isomaltotriose, isomaltotetraose, isomaltooligosaccharide, fructooligosaccharide, levooligosaccharides, galactooligosaccharide, xylooligosaccharide, gentiooligosaccharides, disaccharides, glucose, fructose, galactose, xylose, mannose, sorbose, arabinose, rhamnose, fucose, maltose, sucrose, lactose, maltulose, ribose, lyxose, allose, altrose, gulose, idose, talose, trehalose, nigerose, kojibiose, lactulose, oligosaccharides, maltooligosaccharides, trisaccharides, tetrasaccharides, pentasaccharides, hexasaccharides, oligosaccharides from partial hydrolysates of natural polysacchadde sources and mixtures thereof.

The polysaccharides can be linear, or branched in a variety of ways, such as 1-2, 1-3, 1-4, 1-6, 2-3 and mixtures thereof. Many naturally occurring polysaccharides have at least some degree of branching, or at any rate, at least some saccharide rings are in the form of pendant side groups on a main polysaccharide backbone.

It is desirable that the polysaccharides utilised in the present invention have a molecular weight in the range of from about 10,000 to about 10,000,000, more preferably from about 10,000 to about 1,000,000, most preferably from about 10,000 to about 500,000. It is preferred that polysaccharides of low viscosity are used, especially those having a molecular weight of 10,000 to 50,000.

The natural polysaccharides can be modified with amines (primary , secondary, tertiary), amides, esters, ethers, urethanes, alcohols, carboxylic acids, tosylates, sulfonates, sulfates, nitrates, phosphates and mixtures thereof. Such a modification can take place in position 2, 3 and/or 6 of the saccharide unit. However, it is essential that at least one, preferably more than one, hydroxyl group of the saccharide unit remains unmodified. Such modified or derivatised polysaccharides can be included in the compositions of the present invention in addition to the natural polysaccharides.

It is preferred that the polysaccharide has a total number of sugar units from 10 to 7000, although this figure will be dependent on the type of polysaccharide chosen, at least to some extent.

The polysaccharide can be linear, like in hydroxyalkyl cellulose, it can have an alternating repeat like in carrageenan, it can have an interrupted repeat like in pectin, it can be a block copolymer like in alginate, it can be branched like in dextran, or it can have a complex repeat like in xanthan. Descriptions of the polysaccharides are given in “An introduction to Polysaccharide Biotechnology”, by M. Tombs and S. E. Harding, T. J. Press 1998.

It is especially preferred that the polysaccharide is amylose, starch, amylopectin, guar gum, xanthan gum, tamarind xyloglucan, carrageenan or a derivative thereof. Of these, carrageenan is particularly preferred.

Compositions of the Invention

Compositions of the present invention are preferably formulated into fabric care compositions comprising a solution, dispersion or emulsion comprising a cross-linking agent and a hydroxyl-containing polymer. Such compositions may also include a catalyst and are preferably used in part of a laundering process. The laundering process may be a large scale or small-scale (e.g. domestic) process. When the laundering process is a domestic process, the composition may be packaged and labelled for this use.

The polymer composition comprises a cross-linking agent and a hydroxyl-containing polymer as described above. The composition may contain other components, for example other polymers which impart benefits to a fabric.

In an industrial treatment process, the concentration of cross-linking agent used in the treating solution may be in the range of 0.01% to 20% by weight depending on the solubility of the cross-linking agent and the degree of cellulose crosslinking required as determined by the level of wrinkle resistance, smooth drying properties and shrinkage resistance desired. It is desirable if the level of cross-linking agent is from 0.1% to 20% of the total composition, preferably from 1% to 20%.

If the composition is to be used in a laundry process as part of a conventional fabric treatment product, such as a rinse conditioner or main wash product, it is preferable if the level of cross-linking agent is from 0.01% to 10%, preferably 0.05% to 5%, most preferably 0.1 to 3wt % of the total composition.

If, however, the composition is to be used in a laundry process as a product to specifically treat the fabric to reduce creasing, higher levels of cross-linking agent should be used preferably in amounts of from 0.01% to 15%, more preferably 0.05% to 10%, for example from 0.1 to 5wt % of the total composition.

If the composition is to be used in a spray product it is preferred that the level of cross-linking agent is from 0.5 to 20 wt %, preferably 1 to 10 wt % of the total composition.

If a catalyst is included in the composition, it is preferred that the catalyst is used in a molar ratio of from 5:1 to 1:5, preferably 3:1 to 1:3, catalyst to cross-linking agent. More preferably, if the cross-linking agent is a polycarboxylic acid or derivative thereof and the polycarboxylic acid has n carboxyl groups, n-1 moles of catalyst are used per mole of polycarboxylic acid.

In the present invention, the composition comprises from 0.01% to 15% by weight of the hydroxyl-containing polymer.

Advantageously, in an industrial treatment process, the concentration of hydroxyl-containing polymer used in the treating solution may be in the range from 0.01% to 15% preferably 0.1% to 15%, more preferably 1% to 15%.

If the composition is to be used in a laundry process as part of a conventional fabric treatment product, such as a rinse conditioner or a main wash product, it is preferable that the level of hydroxyl-containing polymer is from 0.01% to 7.5%, preferably 0.05% to 3.75%, more preferably from 0.1 to 2.25%, by weight of the total composition.

If, however, the composition is to be used in a laundry process as a product to specifically treat the fabric to reduce creasing, higher levels of hydroxyl-containing polymer should be used preferably in amounts of from 0.01% to 11.25%, more preferably 0.05% to 7.5%, for example from 0.1 to 3.75wt % of the total composition.

If the composition is to be used in a spray product, it is preferred that the level of hydroxyl-containing polymer is from 0.5 to 15%, preferably 1% to 7.5%, by weight of the total composition.

At these levels of application, the physical properties of the fabric which make it suitable for use in a garment are retained (ie, the overall feel and appearance of the fabric remains substantially unchanged) but, unexpectedly, the fabric has improved crease recovery properties.

The crease recovery properties of a fabric treated according to the present invention are improved relative to fabric not so treated. Treatment of the fabric typically reduces the tendency of the fabric to remain creased. Thus, following treatment according to the invention, the crease recovery angle, which is a measure of the degree to which a fabric returns to its original shape following creasing, increases. The fabric may still require a degree of treatment (eg, by ironing) to reduce its creasing after washing and drying in a conventional domestic laundering process. However, the amount of crease reduction by ironing required for fabric treated according to the invention will typically be less than that required by untreated fabric. It will be appreciated that any reduction in the amount of crease reduction, such as ironing, which is required, is beneficial.

The method of the invention preferably comprises the step of applying a composition of the cross-linking agent and the hydroxyl-containing polymer to a fabric and curing the composition, preferably by ironing. The composition may be applied to the fabric by conventional methods such as dipping, spraying or soaking, for example.

The fabric care composition of the invention preferably comprises a solution, dispersion or emulsion comprising a cross-linking agent and a hydroxyl-containing polymer and a textile compatible carrier. The textile compatible carrier facilitates contact between the fabric and the ingredients of the composition. The textile compatible carrier may be water or a surfactant. However, when it is water, it is preferred that a perfume is present. In a composition that is used during the washing or rinse cycles of a washing machine, it is highly preferable that the textile compatible carrier is a cationic surfactant, more preferably a cationic softening agent.

The method of the invention may be carried out as a treatment of the fabric before or after it has been made into garments, as part of an industrial textile treatment process. Alternatively, it may be provided as a spray composition e.g., for domestic (or industrial) application to fabric in a treatment separate from a conventional domestic laundering process.

Alternatively, in the method of the invention, the treatment is carried out as part of a laundering process. Suitable laundering processes include large scale and small-scale (e.g. domestic) processes. Such a process may involve the use of a fabric care composition of the invention, for example. The fabric care composition of the invention may be a main wash detergent composition, in which case the textile compatible carrier may be a detergent and the composition may contain other additives, which are conventional in main wash detergent compositions. Alternatively, the fabric care composition may be adapted for use in the rinse cycle of a domestic laundering process, such as a fabric conditioning composition or an adjunct, and the textile compatible carrier may be a fabric conditioning compound (such as a quaternary alkylammonium compound) or simply water, and conventional additives such as perfume may be present in the composition.

In one particularly preferred embodiment, the composition may be provided in a form suitable for spraying onto a fabric. The fabric may then be dried, e.g. in a tumble dryer, and then ironed to cure the composition.

If this is the case, it is preferred that the polycarboxylic acid or derivative thereof is present at a level from 0.5 to 20wt %, preferably 0.5 to 10 wt %, of the total composition. If the product is to be used in a spray on product it is also beneficial if wefting agents are also present such as alcohol ethoylates for example, Synperonic A7.

For a spray on formulation anionic surfactants may be present.

Suitable spray dispensing devices are disclosed in WO 96/15310 (Procter & Gamble) and are incorporated herein by reference.

Spray products may contain water as a carrier molecule. In some cases to reduce wrinkling of the fabric it is beneficial for spray products to further comprise ethanol, isopropanol or glycol.

It is advantageous in compositions for use in a domestic setting to further comprise a plasticiser. In the context of this invention, a plasticiser is any material that can modify the flow properties of the thermoplastic elastomer. Suitable plasticisers include C₁₂-C₂₀ alcohols, glycol ethers, phthalates and automatic hydrocarbons. It is also highly advantageous, if the compositions comprise a perfume.

It is particularly advantageous, and surprising, that the composition can be cured by ironing, even under domestic conditions. Moreover, a steam iron can be used, which is desirable to aid wrinkle removal, with no deleterious effects on the curing process.

A further advantage of the method of the invention is that, when the composition is applied as a spray, one application is sufficient to obtain wrinkle benefits for many subsequent washes. Also, application will result in easier ironing of garments.

If the composition is applied during the wash or rinse cycle of a laundry process, a progressive build-up of benefits is observed after each wash, although curing with an iron is required after each wash. Thus, garments become progressively less wrinkled and progressively easier to iron over successive applications.

Detergent Active Compounds

If the fabric care composition of the present invention is in the form of a detergent composition, the textile compatible carrier may be chosen from soap and non-soap anionic, cationic, nonionic, amphoteric and zwitterionic detergent active compounds, and mixtures thereof.

Many suitable detergent active compounds are available and are fully described in the literature, for example, in “Surface-Active Agents and Detergents”, Volumes I and II, by Schwartz, Perry and Berch.

The preferred textile compatible carriers that can be used are soaps and synthetic non-soap anionic and nonionic compounds.

Anionic surfactants are well known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

Cationic surfactants that may be used include quaternary ammonium salts of the general formula R₁R₂R₃R₄N⁺X⁻ wherein the R groups are independently hydrocarbyl chains of C₁-C₂₂ length, typically alkyl, hydroxyalkyl or ethoxylated alkyl groups, and X is a solubilising cation (for example, compounds in which R₁ is a C₈-C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters) and pyridinium salts.

The total quantity of detergent surfactant in the composition is suitably from 0.1 to 60 wt % e.g. 0.5-55 wt %, such as 5-50wt %.

Preferably, the quantity of anionic surfactant (when present) is in the range of from 1 to 50% by weight of the total composition. More preferably, the quantity of anionic surfactant is in the range of from 3 to 35% by weight, e.g. 5 to 30% by weight.

Preferably, the quantity of nonionic surfactant when present is in the range of from 2 to 25% by weight, more preferably from 5 to 20% by weight.

Amphoteric surfactants may also be used, for example amine oxides or betaines.

The compositions may suitably contain from 10 to 70%, preferably from 15 to 70% by weight, of detergency builder. Preferably, the quantity of builder is in the range of from 15 to 50% by weight.

The detergent composition may contain as builder a crystalline aluminosilicate, preferably an alkali metal aluminosilicate, more preferably a sodium aluminosilicate.

The aluminosilicate may generally be incorporated in amounts of from 10 to 70% by weight (anhydrous basis), preferably from 25 to 50%. Aluminosilicates are materials having the general formula:

0.8-1.5 M₂O. Al₂O₃. 0.8-6 SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature.

Fabric Softening and/or Conditioner Compounds

If the fabric care composition of the present invention is in the form of a fabric conditioner composition, the textile compatible carrier will be a fabric softening and/or conditioning compound (hereinafter referred to as “fabric softening compound”), which may be a cationic or nonionic compound.

The softening and/or conditioning compounds may be water insoluble quaternary ammonium compounds. The compounds may be present in amounts of up to 8% by weight (based on the total amount of the composition) in which case the compositions are considered dilute, or at levels from 8% to about 50% by weight, in which case the compositions are considered concentrates.

Compositions suitable for delivery during the rinse cycle may also be delivered to the fabric in the tumble dryer if used in a suitable form. Thus, another product form is a composition (for example, a paste) suitable for coating onto, and delivery from, a substrate e.g. a flexible sheet or sponge or a suitable dispenser during a tumble dryer cycle.

Suitable cationic fabric softening compounds are substantially water-insoluble quaternary ammonium materials comprising a single alkyl or alkenyl long chain having an average chain length greater than or equal to C₂₀ or, more preferably, compounds comprising a polar head group and two alkyl or alkenyl chains having an average chain length greater than or equal to C₁₄. Preferably the fabric softening compounds have two long chain alkyl or alkenyl chains each having an average chain length greater than or equal to C₁₆. Most preferably at least 50% of the long chain alkyl or alkenyl groups have a chain length of C₁₈ or above. It is preferred if the long chain alkyl or alkenyl groups of the fabric-softening compound are predominantly linear.

Quaternary ammonium compounds having two long-chain aliphatic groups, for example, distearyidimethyl ammonium chloride and di(hardened tallow alkyl) dimethyl ammonium chloride, are widely used in commercially available rinse conditioner compositions. Other examples of these cationic compounds are to be found in “Surface-Active Agents and Detergents”, Volumes I and II, by Schwartz, Perry and Berch. Any of the conventional types of such compounds may be used in the compositions of the present invention.

The fabric softening compounds are preferably compounds that provide excellent softening, and are characterised by a chain melting Lβ to Lα transition temperature greater than 25° C., preferably greater than 35° C., most preferably greater than 45° C. This Lβ to Lα transition can be measured by DSC as defined in “Handbook of Lipid Bilayers”, D Marsh, CRC Press, Boca Raton, Fla., 1990 (pages 137 and 337).

Substantially water-insoluble fabric softening compounds are defined as fabric softening compounds having a solubility of less than 1×10⁻³ wt % in demineralised water at 20° C. Preferably the fabric softening compounds have a solubility of less than 1×10⁻⁴ wt %, more preferably less than 1×10⁻⁸ to 1×10⁻⁶ wt %.

Especially preferred are cationic fabric softening compounds that are water-insoluble quaternary ammonium materials having two C₁₂₋₂₂ alkyl or alkenyl groups connected to the molecule via at least one ester link, preferably two ester links. An especially preferred ester-linked quaternary ammonium material can be represented by the formula II:

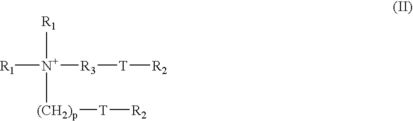

wherein each R₁ group is independently selected from C₁₋₄ alkyl or hydroxyalkyl groups or C₂₋₄ alkenyl groups; each R₂ group is independently selected from C₈₋₂₈ alkyl or alkenyl groups; and wherein R₃ is a linear or branched alkylene group of 1 to 5 carbon atoms, T is

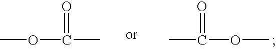

and p is 0 an integer from 1 to 5.

Di(tallowoyloxyethyl) dimethyl ammonium chloride and/or its hardened tallow analogue is especially preferred of the compounds of formula (II).

A second preferred type of quaternary ammonium material can be represented by the formula (III);

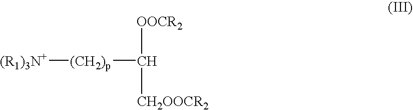

wherein R₁, p and R₂ are as defined above.

It is advantageous if the quaternary ammonium material is biologically biodegradable.

Preferred materials of this class such as 1,2-bis(hardened tallowoyloxy)-3-trimethylammonium propane chloride and their methods of preparation are, for example, described in U.S. Pat. No. 4,137,180 (Lever Brothers Co). Preferably these materials comprise small amounts of the corresponding monoester as described in U.S. Pat. No. 4,137,180, for example, 1-hardened tallowoyloxy-2-hydroxy-3-trimethylammonium propane chloride.

Other useful cationic softening agents are alkyl pyridinium salts and substituted imidazoline species. Also useful are primary, secondary and tertiary amines and the condensation products of fatty acids with alkylpolyamines.

The compositions may alternatively or additionally contain water-soluble cationic fabric softeners, as described in GB 2 039 556B (Unilever).

The compositions may comprise a cationic fabric softening compound and an oil, for example as disclosed in EP-A-0829531.

The compositions may alternatively or additionally contain nonionic fabric softening agents such as lanolin and derivatives thereof.

Lecithins are also suitable softening compounds.

Nonionic softeners include Lβ phase forming sugar esters (as described in M Hato et al Langmuir 12,1659,1666, (1996)) and related materials such as glycerol monostearate or sorbitan esters. Often these materials are used in conjunction with cationic materials to assist deposition (see, for example, GB 2 202 244). Silicones are used in a similar way as a co-softener with a cationic softener in rinse treatments (see, for example, GB 1 549 180).

The compositions may also suitably contain a nonionic stabilising agent. Suitable nonionic stabilising agents are linear C₈ to C₂₂ alcohols alkoxylated with 10 to 20 moles of alkylene oxide, C₁₀ to C₂₀ alcohols, or mixtures thereof.

Advantageously the nonionic stabilising agent is a linear C₈ to C₂₂ alcohol alkoxylated with 10 to 20 moles of alkylene oxide. Preferably, the level of nonionic stabiliser is within the range from 0.1 to 10% by weight, more preferably from 0.5 to 5% by weight, most preferably from 1 to 4% by weight. The mole ratio of the quaternary ammonium compound and/or other cationic softening agent to the nonionic stabilising agent is suitably within the range from 40:1 to about 1:1, preferably within the range from 18:1 to about 3:1.

The composition can also contain fatty acids, for example, C₈ to C₂₄ alkyl or alkenyl monocarboxylic acids or polymers thereof. Preferably saturated fatty acids are used, in particular, hardened tallow C₁₆ to C₁₈ fatty acids. Preferably the fatty acid is non-saponified, more preferably the fatty acid is free, for example oleic acid, lauric acid or tallow fatty acid. The level of fatty acid material is preferably more than 0.1% by weight, more preferably more than 0.2% by weight. Concentrated compositions may comprise from 0.5 to 20% by weight of fatty acid, more preferably 1% to 10% by weight. The weight ratio of quaternary ammonium material or other cationic softening agent to fatty acid material is preferably from 10:1 to 1:10.

The fabric conditioning compositions may include silicones, such as predominately linear polydialkylsiloxanes, e.g. polydimethylsiloxanes or aminosilicones containing amine-functionalised side chains; soil release polymers such as block copolymers of polyethylene oxide and terephthalate; amphoteric surfactants; smectite type inorganic clays; zwitterionic quaternary ammonium compounds; and nonionic surfactants.

The fabric conditioning compositions may also include an agent, which produces a pearlescent appearance, e.g. an organic pearlising compound such as ethylene glycol distearate, or inorganic pearlising pigments such as microfine mica or titanium dioxide (TiO₂) coated mica.

The fabric conditioning compositions may be in the form of emulsions or emulsion precursors thereof.

Other optional ingredients include emulsifiers, electrolytes (for example, sodium chloride or calcium chloride) preferably in the range from 0.01 to 5% by weight, pH buffering agents, and perfumes (preferably from 0.1 to 5% by weight).

Further optional ingredients include non-aqueous solvents, perfume carriers, fluorescers, colourants, hydrotropes, antifoaming agents, antiredeposition agents, enzymes, optical brightening agents, opacifiers, dye transfer inhibitors, anti-shrinking agents, anti-wrinkle agents, anti-spotting agents, germicides, fungicides, anti-oxidants, UV absorbers (sunscreens), heavy metal sequestrants, chlorine scavengers, dye fixatives, anti-corrosion agents, drape imparting agents, antistatic agents and ironing aids. This list is not intended to be exhaustive.

Fabric Treatment Products

The fabric care composition of the invention may be in the form of a liquid, solid (e.g. powder or tablet), a gel or paste, spray, stick or a foam or mousse. Examples including a soaking product, a rinse treatment (e.g. conditioner or finisher) or a mainwash product. The composition may also be applied to a substrate e.g. a flexible sheet or used in a dispenser which can be used in the wash cycle, rinse cycle or during the dryer cycle.

The present invention has the advantage not only of increasing the crease recovery angle of fabric but also of improving the tensile strength (especially the tear strength) of the fabric. Surprisingly, these beneficial effects are durable, that is, they are sustained through a number of subsequent washes without reapplication of the composition of the invention.

The following non-limiting examples illustrate the invention.

### EXAMPLES

Nomenclature:

BTCA: Butane 1,2,3,4-tetracarboxylic acid ex. Aldrich

PVA: Poly(vinyl alcohol), 9,000-10,000 M. W. ex Aldrich

CRA: Crease recovery angle

### Example 1

Wrinkle Recovery and Tear Resistance Performance from BTCA+Catalyst+Poly(vinyl Alcohol) Systems

Poly(vinyl alcohol) was dissolved under stirring and gentle heating in demineralised water. The PVA solutions were allowed to cool before addition of 1,2,3,4-butanetetracarbocylic acid and sodium hypophosphite catalyst. The following solutions were applied to Oxford cotton fabric swatches (20×20 cm) by pad application:

Water (control treatment)

1% BTCA+1% catalyst

2% BTCA+2% catalyst

1% BTCA+1% catalyst+1% PVA

1% BTCA+1% catalyst+2% PVA

2% BTCA+2% catalyst+1% PVA

Fabrics were tumble dried and ironed for 60 seconds per swatch. Fabrics were conditioned in a humidity and temperature controlled room before crease recovery angle and tear resistance measurements were carried out.

Results

| | CRA (degrees) [warp | Mean tearing |
|---|---|---|
| System | direction only] | resistance (kg F) |
| Water | 84.5 | 1.5 |
| 1% btca + 1% catalyst | 102.5 | 0.93 |
| 2% btca + 2% catalyst | 115.3 | 0.69 |
| 1% btca + 1% catalyst + | 111.5 | 0.93 |
| 1% pva | | |
| 1% btca + 1% catalyst + | 114.9 | — |
| 2% pva | | |
| 2% btca + 2% catalyst + | 127.3 | — |
| 1% pva | | |

It is apparent from the results that the presence of PVA improved the crease recovery performance compared to the system containing BTCA+catalyst alone (for a given BTCA and catalyst level)

Also, the presence of PVA did not compromise the tear resistance performance of the fabric more than for the BTCA+catalyst system alone

### Example 2

Wrinkle Recovery and Tear Resistance Performance from BTCA+Catalyst+Carrageenan Systems (and Influence of Iron Time).

Solutions were prepared as above with κ-carrageenan being employed in place of PVA. Following application and tumble drying fabric swatches were ironed for 30 or 60 seconds. Fabrics were conditioned in a humidity and temperature-controlled room before CRA and tearing experiments were carried out.

Results

| | Cure | CRA (degrees) | |
|---|---|---|---|
| | time | [warp direction | Mean tearing |
| System | (secs) | only] | resistance (kg F) |
| water | 30 | 78 | 1.54 |
| 1% btca + 1% catalyst | 30 | 99 | 1.16 |
| 1% btca + 1% catalyst + | 30 | 108 | 1.18 |
| 0.1% κ-carrageenan | | | |
| 1% btca + 1% catalyst + | 30 | 113 | 1.26 |
| 0.5% κ-carrageenan | | | |
| 1% btca + 1% catalyst | 60 | 111 | — |
| 1% btca + 1% catalyst + | 60 | 119 | — |
| 0.5% κ-carrageenan | | | |

It is apparent from the results that, for a given iron time, the presence of κ-carrageenan increased the wrinkle recovery performance.

Also, the mean tearing resistance of the fabric is not affected by the presence of low levels (0.1%) of κ-carrageenan compared to the BTCA+catalyst system alone. Higher levels of κ-carrageenan (0.5%) improve the tearing resistance of the fabric compared to the BTCA+catalyst system alone.

1. A fabric care composition comprising a cross-linking agent and a hydroxyl-containing polymer.

2. A composition according to claim 1, in which the cross-linking agent is selected from the group consisting of carboxylic acids, anhydrides, aldehydes, epoxides, acyl halides, isocyanates, and derivatives thereof.

3. A composition according to claim 1, in which the cross-linking agent is a polycarboxylic acid or a derivative thereof.

4. A composition according to claim 1, in which the cross-linking agent is a polycarboxylic acid or a derivative thereof which contains at least 3 carboxyl groups.

5. A composition according to claim 1, in which the cross-linking agent is 1,2,3,4-butanetetracarboxylic acid.

6. A composition according to claim 1, which further comprises a catalyst.

7. A composition according to claim 6 in which the catalyst is an alkali metal hypophosphite, an alkali metal phosphite, an alkali metal polyphosphate or an alkali metal dihydrogen phosphate.

8. A composition according to claim 6, in which the catalyst is sodium hypophosphite.

9. A composition according to claim 1, in which the hydroxyl-containing polymer is selected from the group consisting of poly(alkenyl alcohols), polysaccharides, polypeptides, hydroxyalkyl-substituted nylons, and derivatives thereof.

10. A composition according to claim 1, in which the hydroxyl-containing polymer is a poly(alkenyl alcohol), a polysaccharide or a derivative thereof.

11. A composition according to claim 1, in which the hydroxyl-containing polymer is poly(vinyl alcohol), poly (allyl alcohol), amylose, starch, amylopectin, guar gum, xanthan gum, tamarind xyloglucan, carrageenan or a derivative thereof.

12. A composition according to claim 1, in which the hydroxyl-containing polymer is poly(vinyl alcohol) or carrageenan.

13. A composition according to claim 1, in which the cross-linking agent is present in an amount of from 0.01% to 20% by weight of the total composition.

14. A composition according to claim 1, in which the hydroxyl-containing polymer is present in an amount of from 0.01% to 15% by weight of the total composition.

15. A composition according to claim 1, which is in a form suitable for spraying onto a fabric.

16. A composition according to claim 1, which forms part of a rinse conditioner or main wash product.

17. A method of treating fabric which comprises treating the fabric with a fabric care composition according to claim 1 and curing the composition.

18. A method according to claim 17, in which the composition is applied to the fabric prior to drying and/or ironing.

19. A method according to claim 17, in which the composition is applied to the fabric during the wash and/or rinse cycle of a laundry process.

20. A method according to claim 17, in which the composition is cured by ironing.

21. Use of a composition according to claim 1 to impart crease and/or wrinkle resistance to a fabric.

22. Use of a hydroxyl-containing polymer as defined in claim 1 to increase the tearing resistance of a fabric.
